(19) United States
(12) Patent Application Publication
(10) Pub. No.: US 2005/0105639 A1
(43) Pub. Date: May 19, 2005

(54) Wireless transmission system

(75) Inventors: Hitoshi Tahara, Osaka (JP); Yuichi Yamamoto, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/984,876

(22) Filed: Nov. 10, 2004

(30) Foreign Application Priority Data
Nov. 13, 2003 (JP) P2003-383634

(51) Int. Cl. H04B 1/38

(52) U.S. Cl. 375/295

(57) ABSTRACT

The present invention relates to a method of wirelessly transmitting data having continuity, while maintaining its continuity, from a transmission apparatus to a reception apparatus in real time. One of the transmission and reception apparatuses in which a recovery from a transmission abnormality generated during data transmission is completed notifies the other apparatus of a recovery completion notice via packet communication. The other apparatus receives the recovery completion notice and implements a recovery operation to dissolve the transmission abnormality generated therein in synchronization with a recovery operation of the one of the apparatuses.

### FIELD OF THE INVENTION

The present invention relates to a method of wirelessly transmitting music data, or the like, in real time and a transmission apparatus and a reception apparatus used in the method, more particularly to a method and a configuration for dissolving an abnormal state, where the data undergoes discontinuity resulting from data omission caused in the wireless transmission followed by a failure to ever normally restore the data, so that a normal state can be regained by synchronizing the transmission apparatus and the reception apparatus with each other

### BACKGROUND OF THE INVENTION

In recent years, the AV profile, which is a standard for real-time transmission of music and images, was defined in Bluetooth as one of close-range wireless communications. The AV profile is shown in Bluetooth SIG, Specification of the Bluetooth System, Profiles, version 1.0, Advanced Distribution Profile and Bluetooth SIG, Specification of the Bluetooth System, Core, version 1.0, Audio/Video Distribution Transport Protocol.

However, in the defined AV profile, when music data, which is treated as continuous data, is transmitted, the absence of a frame as a marker leads to such problems as a buffer overflow generated on a transmission-apparatus side and a buffer exhaustion on a reception-apparatus side, which result in a failure to grasp the continuity of the music data. Therefore, any influence resulting from an error cannot be prevented from being transmitted, and when the data transmission once falls into the discontinuity, it is not possible to regain a normal extension processing.

### SUMMARY OF THE INVENTION

Therefore, a main object of the present invention is, in a system for wirelessly transmitting data required to be continuous in an extension processing in real time, to enable a recovery in which an abnormal transmission state is dissolved to regain a normal transmission state by synchronously operating an recovery processing on transmission and reception sides.

In order to achieve the foregoing object, the present invention relates to a method of wirelessly transmitting continuous data, while maintaining its continuity, in real time from a transmission apparatus to a reception apparatus, wherein one of the transmission and reception apparatuses in which a recovery from the transmission abnormality generated in the data transmission is completed notifies the other apparatus of the completed recovery via packet communication, and the other apparatus in receipt of the notice of the completed recovery is subjected to a recovery processing for the transmission abnormality occurring therein in synchronization with a recovery processing of the one of the apparatuses.

The data handled in the present invention is the continuous data required to maintain the continuity, as an example of which music data can be mentioned. The data may be alternatively image data and, most importantly, any continuous data, based on which the present invention can exert its effect.

The present invention, in the configuration where the data required to maintain its continuity is wirelessly transmitted in real time, enables the recovery from the abnormal state where the continuity cannot be maintained due to data omission, which is a typical problem in the wireless, by arranging the transmission and reception sides to be synchronous with each other.

### BRIEF DESCRIPTION OF THE DRAWINGS

These and other objects of the invention will become clear by the following description of preferred embodiments of the invention with reference to the accompanying drawings and appended claims. Upon implementing the present invention, those skilled in the art will be reminded of a number of benefits, which are not recited herein.

FIG. 1 is a block diagram illustrating a configuration of a transmission apparatus according to a first embodiment of the present invention in a system for wirelessly transmitting music data in real time.

FIG. 2 is a block diagram illustrating a configuration of a reception apparatus according to the first embodiment.

FIG. 3 is a block diagram illustrating a configuration of a transmission apparatus according to a second embodiment of the present invention.

FIG. 4 is a block diagram illustrating a configuration of a reception apparatus according to the second embodiment.

FIG. 5 is a block diagram illustrating a configuration of a transmission apparatus according to a third embodiment of the present invention.

FIG. 6 is a block diagram illustrating a configuration of a reception apparatus according to the third embodiment.

FIG. 7 is a block diagram illustrating a configuration of a transmission apparatus according to a fourth embodiment of the present invention.

FIG. 8 is a block diagram illustrating a configuration of a reception apparatus according to the fourth embodiment.

FIG. 9 is a block diagram illustrating a configuration of a transmission apparatus according to a fifth embodiment of the present invention.

FIG. 10 is a block diagram illustrating a configuration of a reception apparatus according to the fifth embodiment.

FIG. 11 is a block diagram illustrating a basic configuration of a transmission apparatus for transmitting music data in the system for wirelessly transmitting the music data in real time.

FIG. 12 is a block diagram illustrating a basic configuration of a reception apparatus for reserving the music data in a music data buffer for an optional length of time and then starting the reproduction of the data in the system for wirelessly transmitting the music data in real time.

FIG. 13 is a sequence chart of a discontinuity in the music data when an abnormality is generated on a transmission side in the system for wirelessly transmitting the music data in real time.

FIG. 14 is a sequence chart of a discontinuity in the music data when an abnormality is generated on a reception side in the system for wirelessly transmitting the music data in real time.

### DETAILED DESCRIPTION OF THE INVENTION

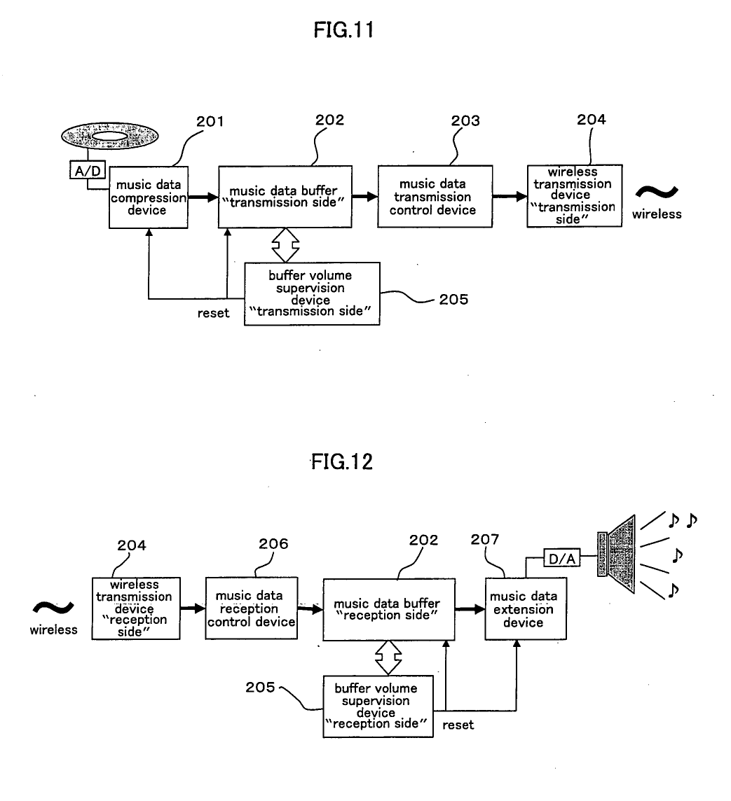

First is described a basic configuration of a system for transmitting music data in real time in conformity with the AV profile of the Bluetooth, in which the present invention is implemented. The system generally comprises a transmission apparatus shown in FIG. 11 and a reception apparatus shown in FIG. 12.

The transmission apparatus comprises a music data compression device 201 for compressing the music data read from CD, MD, or the like, a music data buffer “transmission side” 202 for temporarily retaining the compressed music data, a wireless transmission device “transmission side” 204 for wirelessly transmitting the music data, a music data transmission control device 203 for transmitting the music data from the music data buffer “transmission side” 202 to the wireless transmission device “transmission side” 204 in real time, and a buffer volume supervision device “transmission side” 205 for supervising a buffer volume of the music data buffer “transmission side” 202.

The reception apparatus comprises a wireless transmission device “reception side” 204, a music data buffer “reception side” 202, and a buffer volume supervision device “reception side” 205. These functional devices 204, 202, and 205 are configured in the same manner as the functional devices on the transmission-apparatus side. The reception apparatus further comprises a music data extension device 207 and a music data reception control device 206.

The reception apparatus reserves the music data (compressed) received by the wireless transmission device “reception side” 204 in the music data buffer “reception side” 202 for an optional length of time, and then transmits the music data (compressed) from the music data buffer “reception side” 202 to the music data extension device 207 in real time to extend the music data therein.

The music data transmission control device 203 and the music data reception control device 206 are in conformity with the AV profile of the Bluetooth. The wireless transmission by means of the both wireless transmission devices 204 is based on a protocol constitution in conformity with the AV profile of the Bluetooth.

SBC, AAC, MP3, or the like, in which the music data is compressed per frame, is generally employed as a method of compressing the music data, wherein the real-time transmission of the music data is performed per frame.

Of the respective components of the apparatuses as described, the components attached by “transmission side” or “reception side” indicate that the components having the same configuration are respectively installed in the transmission and reception apparatuses. The components attached by “transmission side” are disposed in the transmission apparatus, while the components attached by“reception side” are disposed in the reception apparatus.

In the transmission and reception arranged in the foregoing manner, the data may be retransmitted or lost, which are typical problems in the wireless data transmission, depending on a status of radio waves. The data retransmission and loss unavoidably occur in the data transmission in the current wireless transmission technology. Due to these phenomena, the music data may overflow in the buffer in the transmission of the music data and exhausted in the buffer in the reception/reproduction of the music data.

When the music data is exhausted in the music data buffer “reception side” 202 on the reception-apparatus side, data omission is generated, which consequently has an adverse influence, such as an error, when the music data is extended.

When the music data overflows in the music data buffer “transmission side” 202 on the transmission-apparatus side, the data omission is generated, which consequently has the adverse influence, such as the error, when the music data is extended.

In order to deal with the problem, in the transmission apparatus, the buffer volume of the music data buffer “transmission side” 202 is supervised by the buffer volume supervision device “transmission side” 205 so that the buffer overflow is detected. When the buffer overflow is detected, the real-time transmission of the music data is restarted after the music data compression device 201 and the music data buffer “transmission side” 202 are reset.

In contrast, in the reception apparatus, the buffer volume of the music data buffer “reception side” 202 is supervised by the buffer volume supervision device “reception side” 205 so that the buffer exhaustion is detected. When the buffer exhaustion is detected, the reception/reproduction of the music data is restarted after the music data extension device 207 and the music data buffer “reception side” 202 are reset.

When the generation of any data error resulting from the data omission is detected by respectively implementing the foregoing processes on the transmission and reception sides, the error is prevented from being transmitted to the time point when the extension processing is executed, and the music data is extended again by means of a new frame to thereby regain a normal reproduction.

The described wireless transmission method does not require the continuity in the data at the time of the extension. Therefore, the process of recovering from the abnormal state does not demand the synchronization between the transmission and reception sides, allowing the respective transmission and reception sides to solely perform the recovery processing.

In the system for wirelessly transmitting the music data in real time, the music data is conventionally transmitted per frame as a general process. In recent years, however, the music data is transmitted by means of a compression method system called ADPCM (Adaptive Differential Pulse Code Modulation), in which the compression/extension processing is not implemented per frame.

The ADPCM is the compression method used for a CD player, and the like, and has an advantage that delays prior to the compression are few because the compression processing is not implemented per frame. However, because the ADPCM is the compression method in which data is encoded by a differential relative to previous data, it is necessary for the data to be continuous when extended.

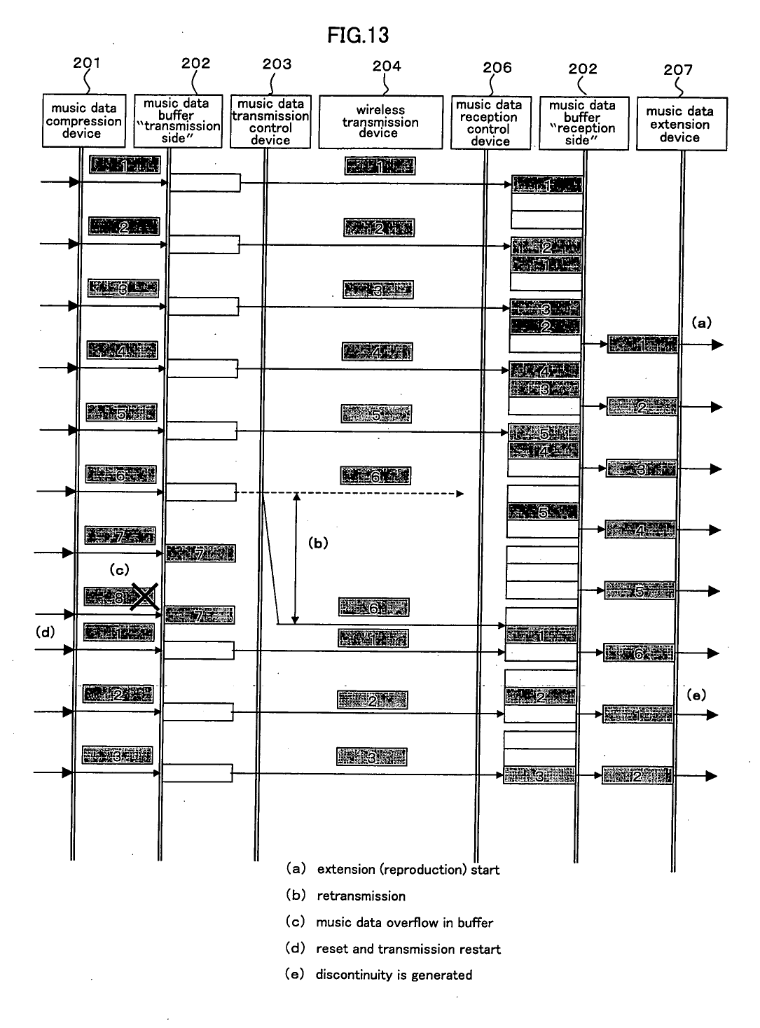

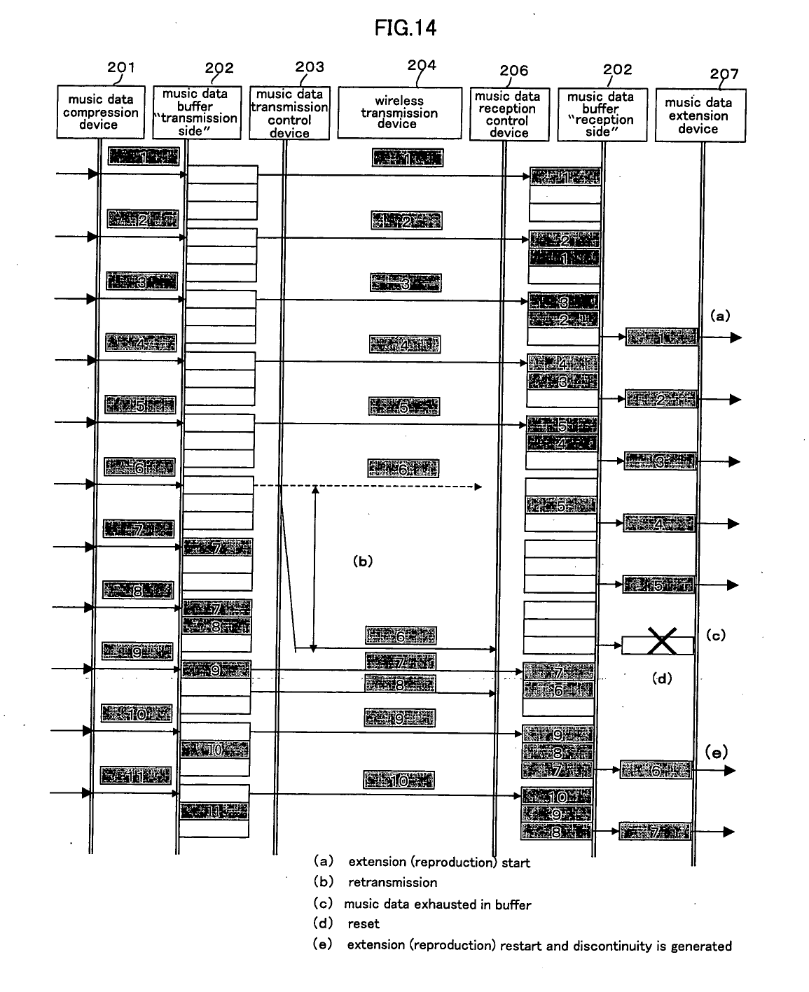

FIGS. 13 and 14 are referenced to describe discontinuity generated in the data in the system for the real-time transmission of the music data compressed according to the compression method, in which the data is required to be continuous, such as the ADPCM. FIG. 13 is a sequence chart in the case where the music data undergoes the discontinuity on the transmission-apparatus side, while FIG. 14 is a sequence chart in the case where the music data undergoes the discontinuity on the reception-apparatus side. In FIGS. 13 and 14, rectangular blocks with continuous numerals inserted therein denote the music data. The numerals denote a passage of time on the music data, wherein time passes on the music data as the numerals increases. Further, a horizontal direction in each of the drawings denotes shifting in the transmission of the music data, wherein the music data transmission shifts from left (respective functional components on the transmission-apparatus side) to right (respective functional components on the reception-apparatus side) in the respective drawings.

FIG. 13 shows the case where the buffer volume of the music data buffer “transmission side” 202 on the transmission-apparatus side is smaller than the buffer volume of the music data buffer “reception side” 202 on the reception-apparatus side. Referring to the case, in the situation where the music data is transmitted in real time and reproduced, when the data transmission is redone between the both wireless transmission devices 204 in the time passage on the music data as shown by (b) in FIG. 13, the buffer overflow is generated in the music data buffer 202 on the transmission-apparatus side as shown by (c) in FIG. 13. In FIG. 13, the music data of the numeral 8 overflows.

The buffer volume supervision device “transmission side” 205 detects the buffer overflow and resets the music data compression device 201 and the music data buffer “transmission side” 202 as shown by (d) in FIG. 13, and then restarts the real-time transmission. On the reception-apparatus side, however, is generated the discontinuity in the music data as shown by (e) in FIG. 13. The discontinuity generated in the data, which is shown by (e) in FIG. 13, is that the data denoted by the numerals, “1”→“2”, is disposed where the data denoted by the numerals, “7”→“8”, is supposed to be disposed subsequent to the data of the numeral, “6”.

The described situation may be acceptable in the case of transmitting the data according to the compression method in which the data continuity is not required in the extension processing. On the contrary, in the case of transmitting the data according to the compression method in which the data continuity is demanded in the extension processing, the discontinuity generated in the data thereafter transmits the error in the extension of the music data, resulting in the abnormal state where the normal extension of the music data is not possible.

Meanwhile, FIG. 14 shows the case where the buffer volume of the music data buffer 202 on the transmission-apparatus side is larger than the buffer volume of the music data buffer 202 on the reception-apparatus side. Referring to the case, in the situation where the music data is transmitted in real time and reproduced, when the data transmission is redone between the both wireless transmission devices 204 in the time passage on the music data as shown (b) in FIG. 14, the data is exhausted in the music data buffer 202 on the reception-apparatus side as shown by (c) in FIG. 14. In FIG. 14, the data is exhausted leading to the halt of the data transmission in the period denoted by (b).

The buffer volume supervision device “reception side” 205 detects the buffer exhaustion, resets the music data extension device 207 and the music data buffer 202 as shown by (d) in FIG. 14, and then restarts the real-time reception/reproduction of the data. However, on the reception-apparatus side, the discontinuity is generated in the music data as shown by (e) in FIG. 14. To describe the data discontinuity shown by (e) in FIG. 14, the data transmission is restarted with the data of the numerals “6”→“7” though the data transmission is supposed to restart with the data of the numeral “1” after the reset. When the data discontinuity is generated, the error is thereafter transmitted to the music data extension, creating the abnormal state where the music data cannot be normally extended.

As described, when the music data, which is handled as the continuous data, is transmitted, it becomes impossible to grasp the continuity of the music data due to the buffer overflow generated on the transmission-apparatus side and buffer exhaustion generated on the reception-apparatus side in the absence of the frame as a marker. Therefore, the transmission of any influence from the error cannot be dissolved. When the data transmission once undergoes the discontinuity, it is not possible to regain the state where the data can be normally extended.

Respective embodiments of the present invention for solving the described inconveniences are hereinafter described.

### FIRST EMBODIMENT

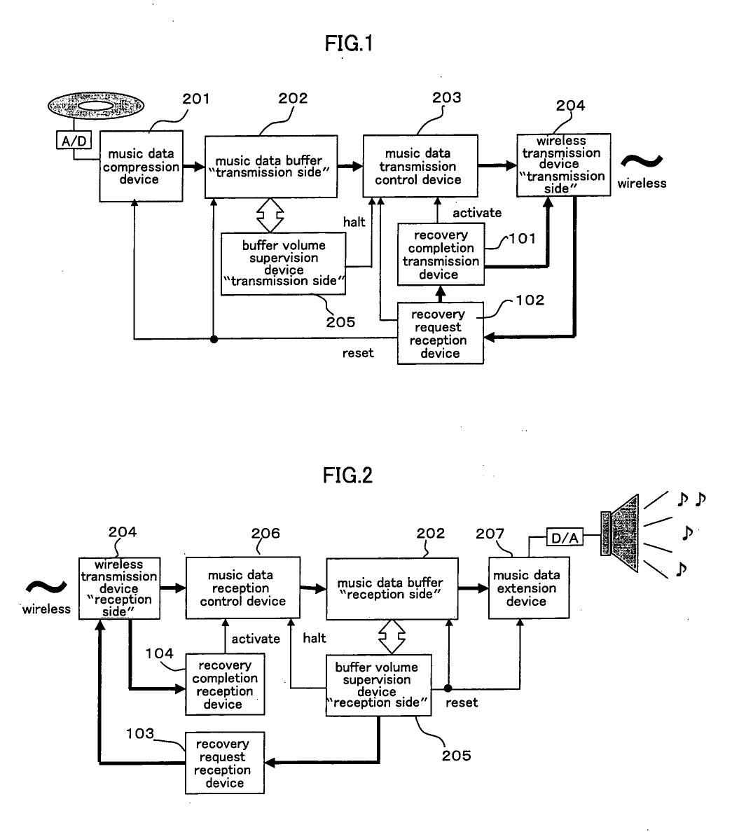

FIG. 1 is a block diagram illustrating a configuration of a transmission apparatus according to a first embodiment of the present invention. FIG. 2 is a block diagram illustrating a configuration of a reception apparatus according to the first embodiment.

Referring to reference numerals in FIGS. 1 and 2, 201 denotes a music data compression device, 202 denotes a music data buffer, 203 denotes a music data transmission control device, 204 denotes a wireless transmission device, and 205 denotes a buffer volume supervision device. The transmission and reception apparatuses according to the present embodiment have a basic configuration same as a system shown in FIGS. 13 and 14. Therefore, any component shown in FIGS. 1 and 2 identical to those in FIGS. 13 and 14 is provided with the same reference numeral and is not described here.

The present embodiment is characterized in that the transmission apparatus comprises a recovery completion transmission device 101 and a recovery request reception device 102, while the reception apparatus comprises a recovery request transmission device 103 and a recovery completion reception device 104.

A method of recovering from the abnormal state in a system according to the first embodiment (system for wirelessly transmitting music data in real time) is described referring to FIGS. 1 and 2. The description below is premised on that the music data is transmitted from the transmission apparatus to the reception apparatus by means of a close-range wireless communication (Bluetooth communication). Based on the premise, in the reception apparatus, the music data received from the wireless transmission device “reception side” 204 is stored in the music data buffer “reception side” 202 by the music data reception control device 206, and extended by the music data extension device 207 to be thereby reproduced.

In the situation where the music data is transmitted in real time and reproduced when the buffer volume of the music data buffer “transmission side” 202 is larger than the buffer volume of the music data buffer “reception side” 202, the data retransmission may be redone between the both wireless transmission devices 204 in the time passage on the music data as shown by (b) in FIG. 14. When the data transmission is redone, the buffer exhaustion is generated in the music data buffer “reception side” 202 as shown by (c) in FIG. 14. Below is described an operation in the case where the buffer exhaustion is generated in the reception apparatus.

In the foregoing case, the buffer volume supervision device “reception side” 205 detects the abnormality in the data transmission (buffer exhaustion). The buffer volume supervision device “reception side” 205, in response to the detection of the buffer exhaustion, resets the operations of the music data buffer “reception side” 202 and the music data extension device 207, and then temporarily halts the operation of the music data reception control device 206.

Thereafter, the buffer volume supervision “reception side” 205 requests the recovery request transmission device 103 to transmit a recovery request packet. The recovery request transmission device 103, in response to the receipt of the request for the transmission of the recovery request packet, creates the recovery request packet and transmits the recovery request packet to the wireless transmission device “transmission side” 204 from the wireless transmission device “reception side” 204 using a data transmission path which is different to a music data transmission path already established between the transmission and reception apparatuses.

The different data transmission path may be established between the transmission and reception apparatuses prior to the real-time transmission of the music data or at the time of requesting the recovery request packet to be transmitted. The different data transmission path may be established at any time point prior to the transmission of the recovery request packet (including the time when the request is made).

At that time, in the transmission apparatus, the music data is compressed by the music data compression device 201 and stored in the music data buffer “transmission side” 202. The music data is then transmitted in real time from the wireless transmission device “transmission side” 204 by the music data transmission control device 204.

When the recovery request reception device 102 receives the recovery request packet from the reception apparatus in the foregoing situation, the recovery request reception device 102 temporarily halts the music data transmission control device 203. The recovery request reception device 102 resets the operations of the music data compression device 201 and the music data buffer “transmission side” 202, and then requests the recovery completion transmission device 101 to transmit a recovery completion packet.

The recovery completion transmission device 101, in response to the received request for the transmission of the recovery completion packet, creates the recovery completion packet and transmits the recovery completion packet to the reception apparatus from the wireless transmission device “transmission side” 204 via the before-mentioned different data transmission path (different to the music data transmission path) established between the transmission and reception apparatuses. After the transmission of the recovery completion packet is completed, the recovery completion transmission device 101 reactivates the music data transmission control device 203 to thereby restart the real-time transmission of the music data.

When the recovery completion reception device 104 receives the recovery completion packet via the wireless transmission device “reception side” 204, the recovery completion reception device 104 reactivates the temporarily halted music data reception control device 206 to thereby restart the reception/reproduction of the music data.

As described, according to the present embodiment, the transmission and reception of the recovery completion packet serve as a timing-wise trigger for restarting the respective real-time transmissions of the music data in the transmission and reception apparatuses. The foregoing arrangement enables synchronization between the timing by which the data compression/transmission in the transmission apparatus is reset and the timing by which the data reception/extension in the reception apparatus is reset. The operation of recovering from the abnormal state generated on the reception side and regaining the normal data transmission state is thereby completed maintaining the synchronous state between the transmission and reception apparatuses.

As described, according to the first embodiment, the reception apparatus can recover from the possible abnormality (buffer exhaustion) generated in the data transmission therein and regain the normal data transmission state within an optimum time length maintaining the synchronous state between the transmission and reception apparatuses in the system for wirelessly transmitting the music data in real time.

Next, a method of recovering from the abnormality (buffer overflow) generated in the data transmission on the transmission-apparatus side is described. In the situation where the music data is transmitted in real time and reproduced when the buffer volume of the music data buffer “transmission side” 202 is smaller than the buffer volume of the music data buffer “reception side” 202, the data transmission maybe redone between the both wireless transmission devices 204 in the time passage on the music data as shown by (b) in FIG. 13. When the data transmission is redone, the buffer overflow is generated in the music data buffer “transmission side” 202 as shown by (c) in FIG. 13. Below is described an operation when the buffer overflow is generated in the transmission apparatus.

In the foregoing case, the buffer volume supervision device “transmission side” 205 detects the abnormality in the data transmission (buffer overflow). The buffer volume supervision device “transmission side” 205, subsequent to the detection of the buffer overflow, halts the transmission of the music data performed by the music data transmission control device 203.

When the operation of the music data transmission control device 203 is temporarily halted, the buffer exhaustion is generated in the music data buffer “reception side” 202 in the reception apparatus.

As described, according to the present embodiment, when the buffer overflow resulting from the abnormality in the data transmission is generated in the music data buffer “transmission side” 202, the transmission operation performed by the music data transmission control device 203 is temporarily halted to thereby intentionally generate the buffer exhaustion in the music data buffer “reception side” 202.

The buffer exhaustion is detected and the recovery operation for the normal data transmission state is executed as described earlier. Thereby, the abnormality in the data transmission (buffer overflow) generated on the transmission-apparatus side can be overcome maintaining the synchronous state between the transmission and reception apparatuses to thereby regain the normal data transmission state.

Thus, according to the present embodiment, the recovery for the normal transmission state can be achieved maintaining the synchronous state between the transmission and reception apparatuses by simply arranging the transmission apparatus to temporarily halt the transmission of the music data when the abnormality (buffer overflow) is generated in the data transmission on the transmission-apparatus side.

The present invention does not place any restriction on the constitutions of the recovery request packet and recovery completion packet and the establishment of the data transmission path according to the first embodiment.

### SECOND EMBODIMENT

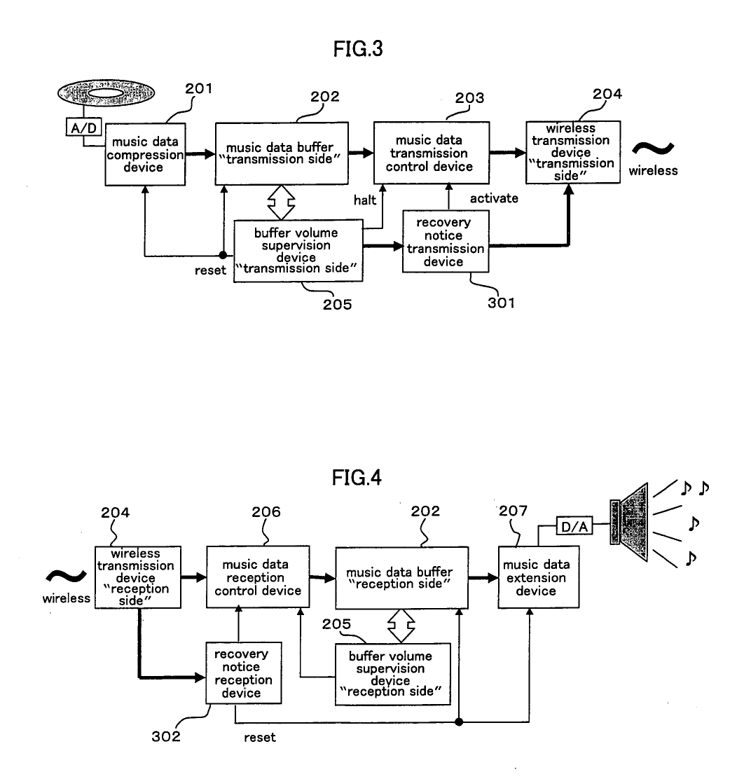

FIG. 3 is a block diagram illustrating a configuration of a transmission apparatus according to a second embodiment of the present invention. FIG. 4 is a block diagram illustrating a configuration of a reception apparatus according to the second embodiment.

Referring to reference numerals in FIGS. 3 and 4, 201 denotes a music data compression device, 202 denotes a music data buffer, 203 denotes a music data transmission control device, 204 denotes a wireless transmission device, and 205 denotes a buffer volume supervision device. The transmission and reception apparatuses according to the present embodiment have a basic configuration same as the system shown in FIGS. 13 and 14. Therefore, any component shown in FIGS. 3 and 4 identical to those in FIGS. 13 and 14 is provided with the same reference numeral and is not described here.

The present embodiment is characterized in that the transmission apparatus comprises a recovery notice transmission device 301, while the reception apparatus comprises a recovery notice reception device 302.

A method of recovering from the abnormal state in a system according to the second embodiment (system for wirelessly transmitting music data in real time) is described referring to FIGS. 3 and 4. The description below, as in the first embodiment, is premised on that the music data is transmitted from the transmission apparatus to the reception apparatus by means of the close-range wireless communication (Bluetooth communication). Based on the premise, in the reception apparatus, the music data received from the wireless transmission device “reception side” 204 is stored in the music data buffer “reception side” 202 by the music data reception control device 206, and extended by the music data extension device 207 to be thereby reproduced.

In the situation where the music data is transmitted in real time and reproduced when the buffer volume of the music data buffer “transmission side” 202 is smaller than the buffer volume of the music data buffer “reception side” 202, the data transmission may be redone between the both wireless transmission devices 204 in the time passage on the music data as shown in by (b) in FIG. 13. When the data transmission is redone, the buffer overflow is generated in the music data buffer “transmission side” 202 as shown by (c) in FIG. 13. Below is an operation in the case where the buffer overflow is generated in the transmission apparatus.

In the foregoing case, the abnormality in the data transmission (buffer overflow) is detected by the buffer volume supervision device “transmission side” 205. The buffer volume supervision device “transmission side” 205, in response to the detection of the buffer overflow, resets the music data compression device 201 and the music data buffer “transmission side” 202, and then temporarily halts the music data transmission control device 203.

Thereafter, the buffer volume supervision device “transmission side” 205 requests the recovery notice transmission device 301 to transmit the recovery notice packet. The recovery notice transmission device 301, in response to the receipt of the request for the transmission of the recovery notice packet, creates the recovery notice packet, and transmits the recovery notice packet to the wireless transmission device “reception side” 204 from the wireless transmission device “transmission side” 204 by means of the data transmission path different to the music data transmission path already established between the transmission and reception apparatuses.

The different data transmission path may be established between the transmission and reception apparatuses prior to the real-time transmission of the music data or at the time of requesting the recovery request packet to be transmitted. The different data transmission path may be established at any time point prior to the transmission of the recovery request packet (including the time when the request is made).

After the transmission of the recovery notice packet is completed, the recovery notice transmission device 301 reactivates the music data transmission control device 203 to thereby restart the real-time transmission “transmission side” of the music data.

The recovery notice reception device 302 receives the recovery notice packet via the wireless transmission device “reception side” 204 and resets the reception/reproduction operations of the music data buffer “reception side” 202 and the music data extension device 207, and then continues the reception/reproduction of the music data. At that time, the recovery notice reception device 302 implements only the reset operation without temporarily halting the operations of the music data buffer “reception side” 202 and the music data extension device 207.

In the foregoing manner, the timing by which the transmission operation of the transmission apparatus is reset and the timing by which the reception/reproduction operation of the reception apparatus is reset synchronize with each other. Accordingly, the abnormal state in the data transmission (buffer overflow) generated on the transmission-apparatus side can be dissolved to thereby regain the normal data transmission state maintaining the synchronous state between the transmission and reception apparatuses.

Thus, according to the second embodiment, the transmission apparatus can recover from the possible abnormality (buffer overflow) generated in the data transmission therein and regain the normal data transmission state within an optimum time length maintaining the synchronous state between the transmission and reception apparatuses in the system for wirelessly transmitting the music data in real time.

Next, a method recovering from the abnormality generated in the data transmission (buffer exhaustion) on the reception-apparatus side is described. In the situation where the music data is transmitted in real time and reproduced when the buffer volume of the music data buffer “transmission side” 202 is larger than the buffer volume of the music data buffer “reception side” 202, the data transmission may be redone between the both wireless transmission devices 204 in the time passage on the music data as shown by (b) in FIG. 14. When the data transmission is redone, the buffer exhaustion is generated in the music data buffer “reception side” 202 as shown by (c) in FIG. 14. Below is an operation in the case where the buffer exhaustion is generated.

In the foregoing case, the buffer volume supervision device “reception side” 205 detects the data exhaustion in the music data buffer “reception side” 202. The buffer volume supervision device “reception side” 205, because of the detected buffer exhaustion, temporarily halts the operation of the music data reception control device 206.

When the operation of the music data reception control device 206 is temporarily halted, the music data is retransmitted between the transmission and reception apparatuses. When the music data is retransmitted, a transmission jam occurs in the transmission apparatus, which results in the buffer overflow.

As described, according to the embodiment, when the buffer exhaustion resulting from the abnormality in the data transmission is generated in the music data buffer “reception side” 202, the reception/reproduction operation of the music data reception control device 206 is temporarily halted to thereby intentionally generate the buffer overflow in the music data buffer “transmission side” 202.

The detection of the buffer overflow and the recovery therefrom to regain the normal data transmission state are implemented as described. When the recovery operation for the normal data transmission state is completed in the transmission apparatus, the recovery notice transmission device 301 transmits the recovery notice packet to the reception apparatus via the wireless transmission device “transmission side” 204. The recovery notice reception device 302 receives the recovery notice packet via the wireless transmission device “reception side” 204 and reactivates the reception operation of the music data reception control device 206 to thereby restart the real-time transmission “reception side ” of the music data.

In the described manner, the timing by which the transmission operation is reset in the transmission apparatus and the timing by which the reception/reproduction operation is reset in the reception apparatus are synchronized with each other. The abnormal state in the data transmission (buffer exhaustion) generated on the reception-apparatus side can be thereby dissolved to regain the normal data transmission state maintaining the synchronous state between the transmission and reception apparatuses.

As described, according to the second embodiment, when the abnormality (buffer exhaustion) is generated in the data transmission state on the reception-apparatus side, the buffer volume supervision device “reception side” 205 halts the operation of the music data reception control device 206, and the music data reception control device 206, if halted when the recovery notice packet is received, is reactivated. A state to be generated the retransmission between the wireless transmission device “reception side” 204 and the music data reception control device 206 is thus eliminated, which enables the normal data transmission state to be regained maintaining the synchronous state between the reception and transmission apparatuses.

The present invention does not place any restriction on the constitution of the recovery notice packet and the generation of the data transmission path according to the second embodiment

### THIRD EMBODIMENT

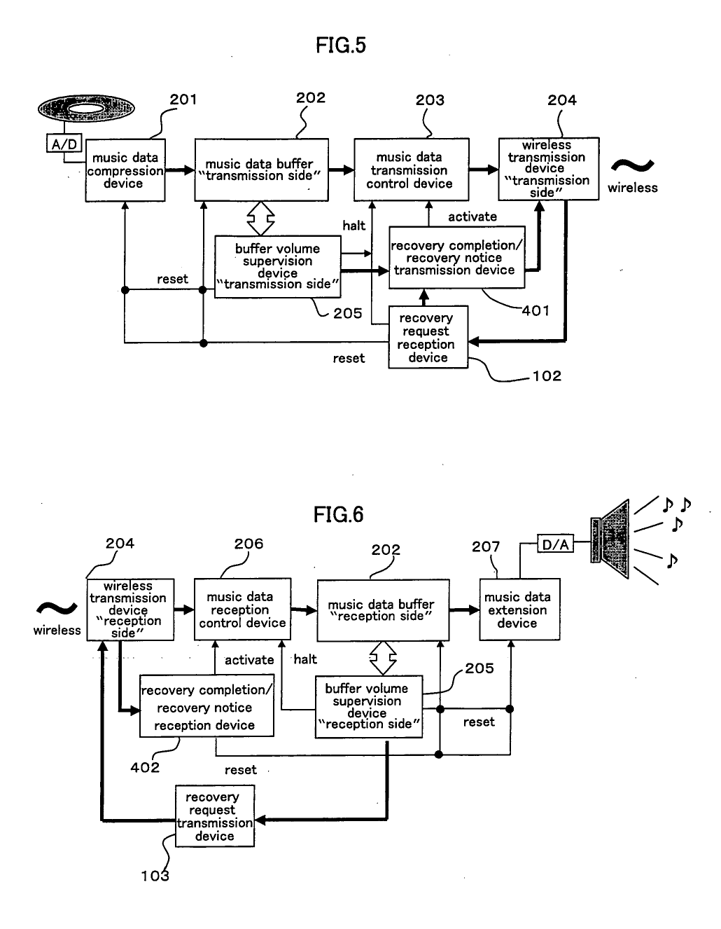

FIG. 5 is a block diagram illustrating a configuration of a transmission apparatus according to a third embodiment of the present invention.

FIG. 6 is a block diagram illustrating a configuration of a reception apparatus according to the third embodiment.

Referring to reference numerals in FIGS. 5 and 6, 201 denotes a music data compression device, 202 denotes a music data buffer, 203 denotes a music data transmission control device, 204 denotes a wireless transmission device, and 205 denotes a buffer volume supervision device. The transmission and reception apparatuses according to the present embodiment have a basic configuration same as the system shown in FIGS. 13 and 14. Therefore, any component shown in FIGS. 5 and 6 identical to those in FIGS. 13 and 14 is provided with the same reference numeral and is not described here.

The present embodiment is characterized in that the transmission apparatus comprises a recovery completion/recovery notice transmission device 401 and a recovery request reception device 102 and the reception apparatus comprises a recovery completion/recovery notice reception device 402 and a recovery request transmission device 103.

A method of recovering from the abnormal state in a system according to the third embodiment (system for wirelessly transmitting music data in real time) is described referring to FIGS. 5 and 6. The description below, as in the first embodiment, is premised on that the music data is transmitted from the transmission apparatus to the reception apparatus by means of the close-range wireless communication (Bluetooth communication). Based on the premise, in the reception apparatus, the music data received from the wireless transmission device “reception side” 204 is stored in the music data buffer “reception side” 202 by the music data reception control device 206, and extended by the music data extension device 207 to be thereby reproduced.

In the situation where the music data is transmitted in real time and reproduced when the buffer volume of the music data buffer “transmission side” 202 is larger than the buffer volume of the music data buffer “reception side” 202, the data transmission may be redone between the both wireless transmission devices 204 in the time passage on the music data as shown in by (b) in FIG. 14. When the data transmission is redone, the buffer exhaustion is generated in the music data buffer “reception side” 202 as shown by (c) in FIG. 14. Below is described an operation in the case where the buffer exhaustion is generated in the reception apparatus.

In the foregoing case, the buffer volume supervision device “reception side” 205 detects the abnormality (buffer exhaustion) in the data transmission. The buffer volume supervision device “reception side” 205, subsequent to the detection of the buffer exhaustion, resets the operations of the music data buffer “reception side” 202 and the music data extension device 207 and temporarily halts the operation of the music data reception control device 206.

Thereafter, the buffer volume supervision device “reception side” 205 requests the recovery request transmission device 103 to transmit the recovery request packet. The recovery request transmission device 103 receives the request for the transmission of the recovery request packet and creates the recovery request packet, and further transmits the recovery request packet from the wireless transmission device “reception side” 204 to the wireless transmission device “transmission side” 204 by means of the data transmission path different to the music data transmission path already established between the transmission and reception apparatuses.

The different data transmission path may be established between the transmission and reception apparatuses prior to the real-time transmission of the music data or at the time of requesting the recovery request packet to be transmitted. The different data transmission path may be established at any time point prior to the transmission of the recovery request packet (including the time when the request is made).

At that time, in the transmission apparatus, the music data is compressed by the music data compression device 201 and stored in the music data buffer “transmission side” 202, and then the music data is transmitted in real time from the wireless transmission device “transmission side” 204 by the music data transmission control device 204.

When the recovery request reception device 102 receives the recovery request packet from the reception apparatus in the foregoing situation, the recovery request reception device 102 temporarily halts the music data transmission control device 203. The recovery request reception device 102 further resets the operations of the music data compression device 201 and the music data buffer “transmission side” 202, and then requests the recovery completion/recovery notice transmission device 401 to transmit the recovery completion packet.

The recovery completion/recovery notice transmission device 401 receives the request for the transmission of the recovery completion packet and creates the recovery completion packet, and then transmits the recovery completion packet from the wireless transmission device “transmission side” 204 to the reception apparatus via the before-mentioned different data transmission path (different to music data transmission path) established between the transmission and reception apparatuses. After the transmission of the recovery completion packet is completed, the recovery completion/recovery notice transmission device 401 reactivates the music data transmission control device 203 to thereby restart the real-time transmission of the music data.

When the recovery completion/recovery notice reception device 402 receives the recovery completion packet via the wireless transmission device “reception side” 204, the recovery completion/recovery notice reception device 402 reactivates the temporarily halted music data reception control device 206 to thereby restart the reception/reproduction of the music data.

As described, according to the present embodiment, the transmission and reception of the recovery completion packet serve as the timing-wise trigger for restarting the respective real-time transmissions of the music data in the transmission and reception apparatuses. Thereby, the timing of resetting the data compression/transmission in the transmission apparatus and the timing of resetting the data reception/extension in the reception apparatus synchronize with each other. In such a manner, the recovery operation, in which the abnormal state generated on the reception side is shifted to the normal data transmission state, is completed maintaining the synchronous state between the transmission and reception apparatuses.

As described, according to the second embodiment, the data transmission undergoing the abnormality (buffer exhaustion) generated on the reception-apparatus side can regain the normal data transmission state within an optimum time length maintaining the synchronous state between the transmission and reception apparatuses in the system for wirelessly transmitting the music data in real time.

Next, a method of recovering from the abnormality (buffer overflow) generated in the data transmission on the transmission-apparatus side is described. In the situation where the music data is transmitted in real time and reproduced when the buffer volume of the music data buffer “transmission side” 202 is smaller than the buffer volume of the music data buffer “reception side” 202, the data transmission may be redone between the both wireless transmission devices 204 in the time passage on the music data as shown by (b) in FIG. 13. When the data transmission is redone, the buffer overflow is generated in the music data buffer “transmission side” 202 as shown by (c) in FIG. 13. Below is described an operation in the case where the buffer overflow is generated in the transmission apparatus.

In the foregoing case, the buffer volume supervision device “transmission side” 205 detects the abnormality (buffer overflow) in the data transmission. The buffer volume supervision device “transmission side” 205, after the detection of the buffer overflow, halts the transmission of the music data performed by the music data transmission control device 203 and further resets the operations of the music data compression device 201 and the music data buffer “transmission side” 202.

After the foregoing control process is implemented, the buffer volume supervision device “transmission side” 205 requests the recovery completion/recovery notice transmission device 401 to transmit the recovery notice packet. The recovery completion/recovery notice transmission device 401 receives the request for the transmission of the recovery notice packet and creates the recovery notice packet, and then transmits the recovery notice packet to the reception apparatus from the wireless transmission device “transmission side” 204 via the before-mentioned different data transmission path established between the transmission and reception apparatuses. After the transmission of the recovery notice packet is completed, the recovery completion/recovery notice transmission device 401 reactivates the music data transmission control device 203 to thereby restart real-time transmission of the music data.

In the reception apparatus, when the recovery completion/recovery notice reception device 402 receives the recovery notice packet via the wireless transmission device “reception side” 204, the recovery completion/recovery notice reception device 402 resets the operations of the music data buffer “reception side” 202 and the music data extension device 207, and then continues the reception/reproduction of the music data. At that time, the recovery completion/recovery notice reception device 402 implements only the reset operation without temporarily halting the operations of the music data buffer “reception side” 202 and the music data extension device 207.

According to the present embodiment, the transmission and reception of the recovery completion packet serve as the timing-wise trigger for synchronizing the timing by which the data compression/transmission is reset in the transmission apparatus and the timing by which the data reception/extension is reset in the reception apparatus relative to each other. Therefore, the recovery operation, in which the abnormal state generated on the reception side dissolved to regain the normal data transmission state, is completed maintaining the synchronous state between the transmission and reception apparatuses.

As described, according to the third embodiment, the data transmission undergoing the abnormality (buffer exhaustion) generated on the reception-apparatus side can regain the normal data transmission state within an optimum time length maintaining the synchronous state between the transmission and reception apparatuses in the system for wirelessly transmitting the music data in real time.

The present invention does not place any restriction on the constitutions of the recovery request packet, recovery completion packet and recovery notice packet and the generation of the data transmission path according to the third embodiment.

### FOURTH EMBODIMENT

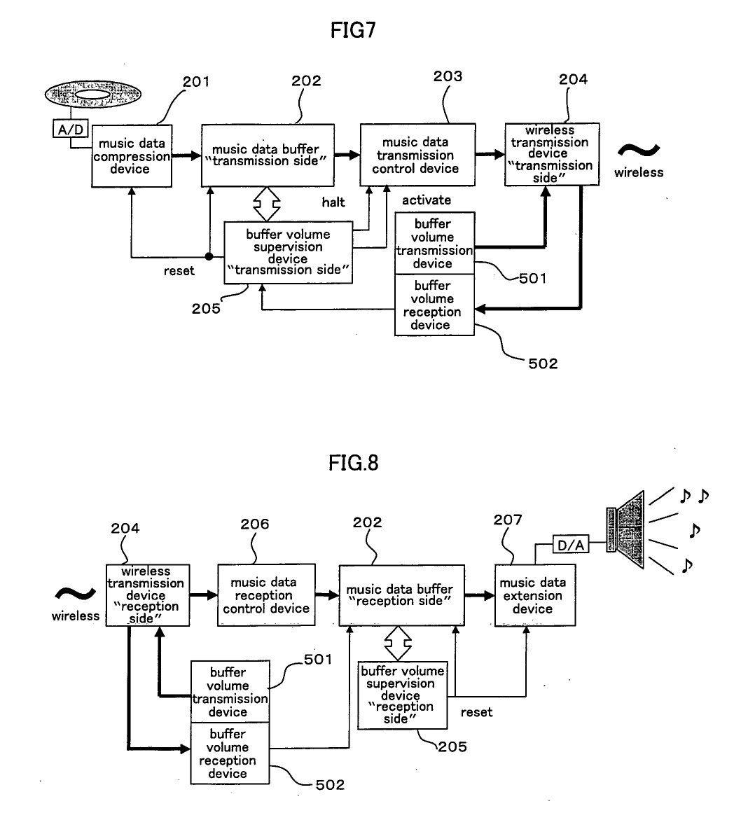

FIG. 7 is a block diagram illustrating a configuration of a transmission apparatus according to a fourth embodiment of the present invention.

FIG. 8 is a block diagram illustrating a configuration of a reception apparatus according to the fourth embodiment.

Referring to reference numerals in FIGS. 7 and 8, 201 denotes a music data compression device, 202 denotes a music data buffer, 203 denotes a music data transmission control device, 204 denotes a wireless transmission device, and 205 denotes a buffer volume supervision device. The transmission and reception apparatuses according to the present embodiment have a basic configuration same as the system shown in FIGS. 13 and 14. Therefore, any component shown in FIGS. 7 and 8 identical to those in FIGS. 13 and 14 is provided with the same reference numeral and is not described here.

The present embodiment is characterized in that the transmission apparatus comprises a buffer volume transmission device “transmission side” 501 and a buffer volume reception device “transmission side” 502, while the reception apparatus comprises a buffer volume transmission device “reception side” 501 and a buffer volume reception device “reception side” 502.

A method of recovering from the abnormal state in a system according to the fourth embodiment (system for wirelessly transmitting music data in real time) is described referring to FIGS. 7 and 8.

The description below is, as in the first embodiment, premised on that the music data is transmitted from the transmission apparatus to the reception apparatus by means of the close-range wireless communication (Bluetooth communication). Based on the premise, in the reception apparatus, the music data received from the wireless transmission device “reception side” 204 is stored in the music data buffer “reception side” 202 by the music data reception control device 206 and extended by the music data extension device 207 to be thereby reproduced.

The present embodiment is characterized in that a buffer volume comparison/supervision value of the buffer volume supervision device “transmission side” 205 is set as the buffer volume of the music data buffer “transmission side” 202 or the music data buffer “reception side” 202 in which the generation of the transmission abnormality is predicted.

When the data transmission is redone between the both wireless transmission devices 204 during the real-time transmission of the music data in the foregoing state, the both transmission abnormalities (buffer overflow on transmission side and buffer exhaustion on reception side) can be detected by the buffer volume supervision device “transmission side” 205.

The present embodiment enables the data transmission abnormalities on the both transmission and reception sides to be detected by the buffer volume supervision device “transmission side” 205 to thereby synchronize the recovery operations in the transmission and reception apparatuses with each other. Below is given the details.

The data transmission path, apart from the music data transmission path, is previously established between the transmission and reception apparatuses before starting the real-time transmission of the music data.

The buffer volume transmission device “transmission side” 501 previously records therein a music data buffer volume (transmission-side buffer volume) capable of reserving the music data in the music data buffer “transmission side” 202. The buffer volume transmission device “transmission side” 501 creates a buffer volume notice packet for notifying the recorded transmission-side buffer volume and transmits the buffer volume notice packet to the reception apparatus via the wireless transmission device “transmission side” 204. The transmission is done through the before-mentioned different data transmission path. The reception apparatus receives the buffer volume notice packet and reads the buffer volume of the music data buffer “transmission side” 202 from the received buffer volume notice packet, and then records the read buffer volume of the music data buffer “transmission side” 202 (transmission-side buffer volume) in the buffer volume reception device “reception side” 502.

In the same manner, the buffer volume transmission device “reception side” 501 previously records therein a music data buffer volume (reception-side buffer volume) capable of reserving the music data in the music data buffer “reception side” 202. The buffer volume transmission device “reception side” 501 creates a buffer volume notice packet for notifying the recorded reception-side buffer volume and transmits the buffer volume notice packet to the transmission apparatus via the wireless transmission device “reception side” 204. The transmission is done through the before-mentioned different data transmission path. The transmission apparatus receives the buffer volume notice packet and reads the buffer volume of the music data buffer “reception side” 202 from the received buffer volume notice packet, and then records the read buffer volume of the music data buffer “reception side” 202 (reception-side buffer volume) in the buffer volume reception device “transmission side” 502. The buffer volume reception device “transmission side” 502 previously records therein the buffer volume of the music data buffer “transmission side” 202 (transmission-side buffer volume).

The transmission-side buffer volume is hypothetically denoted by S, and the reception-side buffer volume by R. The buffer volume reception device “transmission side” 502 sets the buffer volume comparison/supervision value of the buffer volume supervision device “transmission side” 205 for the music data buffer “transmission side” 202 based on the previously recorded transmission-side buffer volume S and the received reception-side buffer volume R. The buffer volume reception device “reception side” 502 modifies the buffer volume of the music data buffer “reception side” 202 based on the previously recorded reception-side buffer volume R and the received transmission-side buffer volume S. Below are given the details.

When the transmission-side buffer volume S is larger than the reception-side buffer volume R (S>R), the buffer volume reception device “transmission side” 502 modifies the buffer volume comparison/supervision value “transmission side” of the buffer volume supervision device “transmission side” 205 to be thereby equal to the reception-side buffer volume R. Further, the buffer volume reception device “transmission side” 502 maintains the buffer volume of the music data buffer “transmission side” 202 to remain equal to the set transmission-side buffer volume S.

At that time, the buffer volume reception device “reception side” 502 maintains the buffer volume comparison/supervision value “reception side” of the buffer volume supervision device “reception side” 205 to remain equal to the reception-side buffer volume R. Further, the buffer volume reception device “reception side” 502 maintains the buffer volume of the music data buffer “reception side” 202 to remain equal to the set reception-side buffer volume R.

When the transmission-side buffer volume S is smaller than the reception-side buffer volume R (S<R), the buffer volume reception device “transmission side” 502 maintains the buffer volume comparison/supervision value “transmission side” of the buffer volume supervision device “transmission side” 205 to remain equal to the set transmission-side buffer volume S. The buffer volume reception device “transmission side” 502, further, maintains the buffer volume of the music data buffer “transmission side” 202 to remain equal to the set transmission-side buffer volume S.

At that time, the buffer volume reception device “reception side” 502 modifies the buffer volume of the music data buffer “reception side” 202 to be thereby equal to the transmission-side buffer volume S. Further, the buffer volume reception device “reception side” 502 maintains the buffer volume comparison/supervision value “reception side” of the buffer volume supervision device “reception side” 205 to remain equal to the set reception-side buffer volume R.

As described, the reception buffer volume of the music data buffer “reception side” 202 and the comparison/supervision value of the buffer volume supervision device “transmission side” 205 are reset based on the comparison between the buffer volume of the music data buffer “transmission side” 202 and the buffer volume of the music data buffer “reception side” 202. More specifically, the buffer volume of the music data buffer “reception side” 202 is set to one of the buffer volume S of the music data buffer “transmission side” 202 and the buffer volume R of the music data buffer “reception side” 202 smaller than the other. Further, the buffer volume comparison/supervision value “transmission side” of the buffer volume supervision device “transmission side” 205 is set to one of the buffer volume S of the music data buffer “transmission side” 202 and the buffer volume R of the music data buffer “reception side” 202 smaller than the other.

After the adjustments of the buffer volume comparison/supervision value and the reception-side buffer volume are completed, the different data transmission path, which is different to the music data transmission path, is disconnected. However, the present embodiment does not place the restriction that the data transmission path has to be disconnected. The different data transmission path, apart from the music data transmission path, may remain connected.

After the adjustments of the buffer volume comparison/supervision value and the buffer volume are completed, the music data is transmitted in real time. During the data transmission, when the buffer volume of the music data buffer “transmission side” 202 exceeds the buffer volume comparison/supervision value “transmission side” previously set in the buffer volume supervision device “transmission side” 205, the buffer volume supervision device “transmission side” 205 detects the fact. The buffer volume supervision device “transmission side” 205, subsequent to the detection of the excessive buffer volume, judges that the buffer overflow is generated on the transmission side and temporarily halts the transmission operation of the music data transmission control device 203, and then resets the operations of the music data compression device 201 and the music data buffer “transmission side” 202. When the reset operation is done, the buffer volume supervision device “transmission side” 205 reactivates the music data transmission control device 203 to thereby restart the real-time transmission of the music data.

The buffer volume comparison/supervision value “transmission side” of the buffer volume supervision device “transmission side” 205 is set to a value equal to one of the buffer volume S of the music data buffer “transmission side” 202 and the buffer volume R of the music data buffer “reception side” 202 smaller than the other. The reception buffer volume of the music data buffer “reception side” 202 is set to a value equal to one of the buffer volume S of the music data buffer “transmission side” 202 and the buffer volume R of the music data buffer “reception side” 202 smaller than the other. Therefore, the synchronization for restarting the transmission is maintained in the following manner.

First is described the case where the buffer volume S of the music data buffer “transmission side” 202 (transmission-side buffer volume) is larger than the buffer volume R of the music data buffer “reception side” 202 (reception-side buffer volume) (S>R).

In the foregoing case, when the buffer volume supervision device “reception side” 205 detects the transmission abnormality (buffer exhaustion) generated in the music data buffer “reception side” 202, the buffer volume supervision device “transmission side” 205 simultaneously detects the supposed buffer overflow.

Because of that, when the buffer exhaustion in the music data buffer “reception side” 202 is detected by the buffer volume supervision device “reception side” 205 and the data transmission on the reception side is correspondingly reset and restarted, the supposed buffer overflow in the music data buffer “transmission side” 202 is simultaneously (synchronously) detected by the buffer volume supervision device “transmission side” 205, and the data transmission on the transmission side is correspondingly reset and restarted.

Therefore, the timing by which the reception/reproduction restarts in the reception apparatus synchronizes with the timing by which the transmission restarts in the reception apparatus.

Next is described the case where the buffer volume S of the music data buffer “transmission side” 202 (transmission-side buffer volume) is smaller than the buffer volume R of the music data buffer “reception side” 202 (reception-side buffer volume) (S<R).

In the foregoing case, when the buffer volume supervision device “transmission side” 205 detects the buffer overflow in the music data buffer “transmission side” 202, the buffer volume supervision device “reception side” 205 simultaneously (synchronously) detects the buffer overflow in the music data buffer “reception side” 202.

Therefore, the timing of resetting the music data buffer “transmission side” 202 and the music data compression device 201 based on the detection by the buffer volume supervision “transmission side” 205 and the timing of resetting the music data buffer “reception side” 202 and the music data extension device 207 based on the detection by the buffer volume supervision device “reception side” 205 synchronize with each other.

Thus, according to the fourth embodiment, in the system for wirelessly transmitting the music data in real time, the buffer comparison supervision value “transmission side” of the buffer volume supervision device “transmission side” 205 is reset and the buffer volume of the music data buffer “reception side” 202 is adjusted between the transmission and reception apparatuses before the real-time transmission of the music data starts to thereby synchronize the timing by which the abnormality is generated in the data transmission in the transmission apparatus and the timing by which the abnormality is generated in the data transmission in the reception apparatus. In such a manner, even when the respective recovery operations for the normal transmission state are separately performed in the transmission and reception apparatuses, the recovery operations can be still synchronously performed.

According to the recovery from the abnormal transmission state constituted according to the present embodiment, it is unnecessary to transmit any data other than the music data during the real-time transmission of the music data, which reduces a processing load required for the recovery operation.

### FIFTH EMBODIMENT

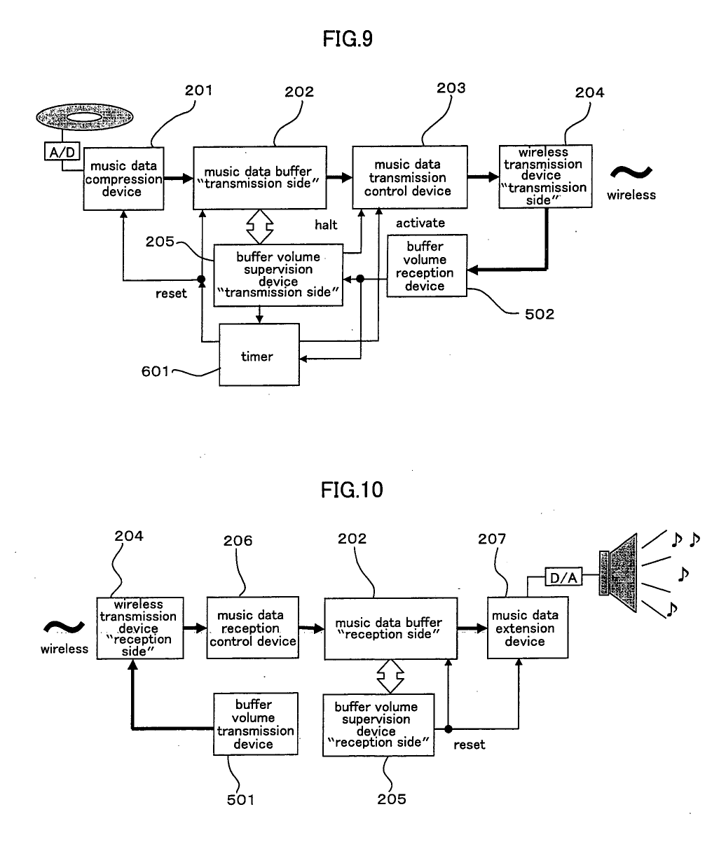

FIG. 9 is a block diagram illustrating a configuration of a transmission apparatus according to a fifth embodiment of the present invention. FIG. 10 is a block diagram illustrating a configuration of a reception apparatus according to the fifth embodiment.

Referring to reference numerals in FIGS. 9 and 10, 201 denotes a music data compression device, 202 denotes a music data buffer, 203 denotes a music data transmission control device, 204 denotes a wireless transmission device, and 205 denotes a buffer volume supervision device. The transmission and reception apparatuses according to the present embodiment have a basic configuration same as a system shown in FIGS. 13 and 14. Therefore, any component shown in FIGS. 9 and 10 identical to those in FIGS. 13 and 14 is provided with the same reference numeral and is not described here.

The present embodiment is characterized in that the transmission apparatus comprises a buffer volume reception device “transmission side” 502 and a timer 601, while the reception apparatus comprises a buffer volume reception device “reception side” 501.

A method of recovering from the abnormal state in a system (system for wirelessly transmitting the music data in real time) according to the fifth embodiment is described referring to FIGS. 9 and 10.

The description below, as in the first embodiment, is premised on that the music data is transmitted from the transmission apparatus to the reception apparatus by means of the close-range wireless communication (Bluetooth communication). Based on the premise, in the reception apparatus, the music data received from the wireless transmission device “reception side” 204 is stored in the music data buffer “reception side” 202 by the music data reception control device 206, and extended by the music data extension device 207 to be thereby reproduced.

According to the fourth embodiment, the buffer volume comparison/supervision value of the buffer volume supervision device “transmission side” 205 and the buffer volume of the music data buffer “reception side” 202 (reception-side buffer volume) are set as the buffer volume of the music data buffer “transmission side” 202 or the music data buffer “reception side” 202 in which the data transmission abnormality is predicted.

According to the present embodiment, only the buffer volume comparison/supervision value of the buffer volume supervision device “transmission side” 205 is set as the buffer volume of the music data buffer “transmission side” 202 or the music data buffer “reception side” 202 in which the data transmission abnormality is predicted. The buffer volume comparison/supervision value of the buffer volume supervision device “reception side” 205 is arranged to be the original buffer volume comparison/supervision value (buffer volume of music data buffer “reception side” 202). Instead, the timer 601 is provided in the transmission apparatus in the present embodiment.

The data transmission path, apart from the music data transmission path, is previously established between the transmission and reception apparatuses before the real-time transmission of the music data starts.

The buffer volume transmission device “reception side” 501 previously records therein the music data buffer volume capable of reserving the music data in the music data buffer “reception side” 202. The buffer volume transmission device “reception side” 501 creates a buffer volume notice for notifying the recorded music data buffer volume, and then transmits the buffer volume notice to the transmission apparatus by means of the packet communication via the wireless transmission device “reception side” 204. The transmission is done through the before-mentioned different data transmission path. The transmission apparatus receives the buffer volume notice and reads the buffer volume of the music data buffer “reception side” 202 from the received buffer volume notice, and then records the read buffer volume of the music data buffer “reception side” 202 (reception-side buffer volume) in the buffer volume reception device “transmission side” 502. At that time, the buffer volume reception device “transmission side” 502 previously records therein the buffer volume of the music data buffer “transmission side” 202 (transmission-side buffer volume).

The transmission-side buffer volume is hypothetically denoted by S, and the reception-side buffer volume by R. Further, a time calculated from a differential between the transmission-side buffer volume S and the reception-side buffer volume R and a data transfer rate in the real-time transmission is hypothetically denoted by T.

The buffer volume reception device “transmission side” 502 sets the buffer volume comparison/supervision value of the buffer volume supervision device “transmission side” 205 for the music data buffer “transmission side” 202 based on the transmission-side buffer volume S and the received reception-side buffer volume R. Further, a timer setting time T of the timer 601 is set based on the transmission-side buffer volume S and the reception-side buffer volume R. The timer setting time T denotes a time difference between time points when the abnormal state is generated in the data transmission in the transmission and reception apparatuses. Below is described the details.

When the transmission-side buffer volume S is larger than the reception-side buffer volume R (S>R), the buffer volume reception device “transmission side” 502 modifies the buffer volume comparison/supervision value “transmission side” of the buffer volume supervision device “transmission side” 205 to be thereby equal to the reception-side buffer volume R. At that time, the buffer volume reception device “reception side” 502 sets the timer setting time (time difference between time points when abnormal state is generated) T of the timer 601 to “0”.

When the transmission-side buffer volume S is smaller than the reception-side buffer volume R (S<R), the buffer volume reception device “transmission side” 502 maintains the buffer volume comparison/supervision value “transmission side” of the buffer volume supervision device “transmission side” 205 to remain equal to the transmission-side buffer volume S. At that time, the buffer volume reception device “reception side” 502 sets the timer setting time (time difference between time points when abnormal state is generated) T of the timer 601 from the differential between the transmission-side buffer volume R and the reception-side buffer volume S and the data transfer rate in the real-time transmission. For example, when the transfer rate in the real-time transmission is 384 k bps and (R−S) is 48 bytes, the timer setting time T is calculated as 1 msec.

After the buffer volume comparison/supervision value and the timer setting time T are set as described, the data transmission path different to the music data transmission path is disconnected. However, the present embodiment does not include a limitation that the disconnection is necessary.

After the buffer volume comparison/supervision value and the timer setting time T are set as described, the music data is transmitted in real time.

First is described the case where the transmission-side buffer volume S is larger than the reception-side buffer volume R (S>R). In such a case, when the buffer volume in the music data buffer “transmission side” 202 exceeds the buffer volume (R) previously set in the buffer volume supervision device “transmission side” 205 during the data transmission, the buffer volume supervision device “transmission side” 205 detects that. The buffer volume supervision device “transmission side” 205, subsequent to the detection of the excessive buffer volume, judges that the buffer exhaustion is generated in the music data buffer “reception side” 202 in the reception apparatus and temporarily halts the transmission operation of the music data transmission control device 203, and then outputs an instruction to reset the transmission operation to the timer 601.

The timer 601 receives the reset instruction and waits for the timeout of the previously set timer setting time T and resets the operations of the music data compression device 201 and the music data buffer “transmission side” 202. Because the transmission-side buffer volume S is larger than the reception-side buffer volume R (S>R), the timer setting time T is set to “0”. Therefore, the timer 601 immediately resets the operations of the music data compression device 201 and the music data buffer “transmission side” 202 with no timeout (timeout 0), and then reactivates the music data transmission control device 203 to thereby restart the real-time transmission of the music data.

Thereby, the buffer exhaustion generated in the music data buffer “reception side” 202 is detected by the buffer volume supervision device “transmission side” 205 at an identical time point. Then, the operations of the music data compression device 201 and the music data buffer “transmission side” 202 in the transmission apparatus are reset in synchronization with the identical detection time point.

Next is described the case where the transmission-side buffer volume S is smaller than the reception-side buffer volume R (S<R). In that case, when the buffer volume in the music data buffer “transmission side” 202 exceeds the buffer volume S previously set in the buffer volume supervision device “transmission side” 205 during the data transmission, the buffer volume supervision device “transmission side” 205 detects that. The buffer volume supervision device “transmission side” 205, subsequent to the detection of the excessive buffer volume, judges that the buffer overflow is generated in the music data buffer “transmission side” 202 in the transmission apparatus and temporarily halts the transmission operation of the music data transmission control device 203, and then outputs the instruction to reset the transmission operation to the timer 601.

The timer 601 receives the reset instruction and waits for the timeout of the previously set timer setting time T and resets the operations of the music data compression device 201 and the music data buffer “transmission side” 202. Because the transmission-side buffer volume S is smaller than the reception-side buffer volume R (S<R), the timer setting time T is previously set from the differential between the transmission-side buffer volume Rand the reception-side buffer volume S and the transfer rate in the real-time transmission. Therefore, the timer 601 delays the timing of resetting the operations of the music data compression device 201 and the music data buffer “transmission side” 202 by the timer setting time T which is already set. An amount of the delay (timer setting time T) is set in order to achieve the following object.

In the case where the transmission abnormality (buffer overflow) is generated in the music data buffer “transmission side” 202, the timing by which the reception-side transmission abnormality (buffer exhaustion) resulting from the transmission-side transmission abnormality (buffer overflow) is generated in the music data buffer “reception side” 202 is delayed relative to the timing by which the transmission-side transmission abnormality (buffer overflow) is generated. Therefore, if the reception-side transmission abnormality (buffer exhaustion) caused by the transmission-side transmission abnormality (buffer overflow) is detected by the buffer volume supervision device “reception side” 205 and the operations of the music data buffer “reception side” 202 and the music data extension device 207 are reset when the foregoing detection is done, the timing of the transmission-side recovery operation and the timing of the reception-side recovery operation cannot possibly be identical.

Therefore, according to the present embodiment, when the transmission abnormality (buffer overflow) is generated in the music data buffer “transmission side” 202, because of the generated delay, a focus is placed on that the timing by which the operations of the music data buffer “transmission side” 202 and the music data compression device 201 on the transmission-apparatus side are reset is necessarily delayed relative to the timing by which the transmission abnormality (buffer overflow) is detected by the buffer volume supervision device “transmission side” 205. In such a manner, the reset operations in the transmission and reception apparatuses can be synchronously performed.

The before-mentioned delay amount is determined by the differential between the transmission-side buffer volume S and the reception-side buffer volume R and the transfer rate in the real-time transmission. To be more specific, providing that S<R, the buffer exhaustion is not yet generated on the reception side when the buffer overflow is generated on the transmission side because the buffer equivalent to (R−S) is not yet consumed on the reception side. A time length for consuming the buffer equivalent to (R−S) constitutes the delay amount (timer setting time of timer 601). Further, the delay amount is calculated as (R−S)/44.1 [msec] in the case of the music data compressed to one byte in 44.1 Khz sampling.

According to the present embodiment, the time length by which the timing by which the transmission abnormality (buffer exhaustion) is generated on the reception side is delayed relative to the timing by which the transmission abnormality (buffer overflow) is generated on the transmission side is corrected by delaying the reset of the transmission operation on the transmission-apparatus side using the timer 601. The timing by which the reception/reproduction restarts in the reception apparatus is thereby synchronized with the timing by which the transmission restarts in the transmission apparatus.

As described, according to the fifth embodiment, in the system for wirelessly transmitting the music data in real time, the transmission-apparatus side is notified of the buffer volume on the reception-apparatus side before the real-time transmission of the music data starts to thereby synchronize the timings when the respective abnormalities are generated on the transmission and reception sides. Thereby, when the recovery operations to regain the normal transmission state are individually performed on the transmission-apparatus side and reception-apparatus side, the respective recovery operations can be synchronously performed. According to the abnormality-recovery process constituted as described, the reception apparatus can be more simply configured than in the fourth embodiment.

While there has been described what is at present considered to be preferred embodiments of this invention, it will be understood that various modifications may be made therein, and it is intended to cover in the appended claims all such modifications as fall within the true spirit and scope of this invention.

1. A wireless transmission method for transmitting data having continuity in real time maintaining the continuity from a transmission apparatus to a reception apparatus, comprising:
a step wherein one of the transmission and the reception apparatuses in which a recovery from a transmission abnormality generated in the data transmission is completed notifies the other apparatus of a recovery completion notice via packet communication; and
a step wherein a recovery operation for dissolving the transmission abnormality generated in the other apparatus notified of the recovery completion notice is implemented in the other apparatus in synchronization with a recovery operation of the one of the apparatuses.

2. A wireless transmission method for transmitting data having continuity in real time maintaining the continuity from a transmission apparatus to a reception apparatus, comprising:
a step wherein a reception operation is halted and reset to thereby enable a recovery from an abnormal state in the data transmission in the reception apparatus by which a transmission abnormality is detected in receive data;
a step wherein a recovery request for the transmission apparatus is transmitted to the transmission apparatus via packet communication different to the data transmission in the reception apparatus;
a step wherein a transmission operation is reset and halted to thereby enable the transmission apparatus to recover from the abnormal state in the data transmission in the transmission apparatus by which the recovery request is received;
a step wherein a recovery completion notice is transmitted to the reception apparatus via the packet communication different to the data transmission in the transmission apparatus;
a step wherein the data transmission operation is restarted at a timing by which the transmission of the recovery completion notice is completed in the transmission apparatus by which the recovery completion notice is transmitted; and
a step wherein the data reception operation is restarted at a timing by which the recovery completion notice is received to thereby synchronize the timing of restarting the data reception operation with a timing by which the data transmission operation is restarted in the reception apparatus by which the recovery completion notice is received.

3. A wireless transmission method as claimed in claim 2, further comprising:
a step wherein the transmission operation is halted in the transmission apparatus by which the transmission abnormality is detected in transmit data to thereby generate the transmission abnormality in receive data in the reception apparatus.

4. A reception apparatus for implementing the wireless transmission method as claimed in claim 2, comprising:
a buffer volume supervision device for supervising the transmission abnormality in receive data and enabling the reception apparatus to recover from the abnormal state in the data transmission by halting and resetting the reception operation when the transmission abnormality is detected;
a recovery request transmission device for transmitting the recovery request for the transmission apparatus to the transmission apparatus via the packet communication different to the data transmission when a recovery operation is completed in the reception apparatus; and
a recovery completion reception device for synchronizing the timing of restarting the data reception operation with the timing of restarting the data transmission operation by restarting the data reception operation in response to the reception of the recovery completion notice transmitted by the transmission apparatus at a timing of the reception.

5. A transmission apparatus for implementing the wireless transmission method as claimed in claim 2, comprising:
a recovery request reception device for enabling the transmission apparatus to recover from the abnormal state in the data transmission by halting and resetting the transmission operation in response to the reception of the recovery request transmitted by the reception apparatus via the packet communication; and
a recovery completion transmission device for transmitting the recovery completion notice of the transmission apparatus to the reception apparatus via the packet communication different to the data transmission and restarting the data transmission operation at a timing by which the recovery completion notice is transmitted.

6. A transmission apparatus as claimed in claim 5, further comprising a buffer volume supervision device for supervising the transmission abnormality in transmit data and generating the transmission abnormality in the receive data in the reception apparatus by halting the transmission operation when the transmission abnormality is detected in the transmit data.

7. A wireless transmission method for transmitting data having continuity in real time maintaining the continuity from a transmission apparatus to a reception apparatus, comprising:
a step wherein a transmission operation is halted and reset to thereby enable the transmission apparatus to recover from an abnormal state in the data transmission in the transmission apparatus by which a transmission abnormality is detected in transmit data;
a step wherein a recovery notice is created and transmitted to the reception apparatus via packet communication different to the data transmission and the transmission operation is restarted after the completion of the transmission in the transmission apparatus; and
a step wherein a data reception operation is reset at a timing by which the recovery notice is received to thereby synchronize a timing by which the data reception operation is restarted with a timing by which the data transmission operation is restarted in the reception apparatus by which the recovery notice is received.

8. A wireless transmission method as claimed in claim 7, further comprising a step wherein the reception operation is halted in the reception apparatus by which the transmission abnormality is detected in receive data to thereby generate the transmission abnormality in the transmit data in the transmission apparatus.

9. A transmission apparatus for implementing the wireless transmission method as claimed in claim 7, comprising:
a buffer volume supervision device for supervising the transmission abnormality in the transmit data and enabling the transmission apparatus to recover from the abnormal state in the data transmission by halting and resetting the transmission operation when the transmission abnormality is detected; and
a recovery completion notice transmission device for transmitting the recovery notice to the reception apparatus via the packet communication different to the data transmission when a recovery operation for the transmission apparatus is completed and restarting the data transmission operation at a timing by which the recovery notice is transmitted.

10. A reception apparatus for implementing the wireless transmission method as claimed in claim 7, comprising:
a recovery notice reception device for enabling the reception apparatus to recover from the abnormal state in the data transmission by resetting the reception operation when the recovery notice transmitted by the transmission apparatus is received.

11. A reception apparatus as claimed in claim 10, further comprising:
a buffer volume supervision device for supervising the transmission abnormality in receive data and generating the transmission abnormality in the transmit data in the transmission apparatus by halting the reception operation when the transmission abnormality is detected in the receive data.

12. A wireless transmission method for transmitting data having continuity in real time maintaining the continuity from a transmission apparatus to a reception apparatus, comprising:
as a recovery process when a transmission abnormality is generated in the reception apparatus,
a step wherein a reception operation is halted and reset to thereby enable the reception apparatus to recover from an abnormal state in the data transmission in the reception apparatus by which the transmission abnormality is detected;
a step wherein a recovery request for the transmission apparatus is transmitted to the transmission apparatus via packet communication different to the data transmission in the reception apparatus;
a step wherein a transmission operation is reset and halted in the transmission apparatus by which the recovery request is received to thereby enable the transmission apparatus to recover from the abnormal state in the data transmission in the transmission apparatus by which the recovery request is received;
a step wherein a recovery completion notice is transmitted to the reception apparatus via the packet communication different to the data transmission in the transmission apparatus recovered from the abnormal state in the data transmission; and
a step wherein the data reception operation is restarted at a timing by which the recovery completion notice is transmitted to thereby synchronize the timing by which the data reception is restarted with a timing by which the data transmission operation is restarted in the reception apparatus by which the recovery completion notice is received, and further comprising:
as a recovery process when the transmission abnormality is generated in the transmission apparatus,
a step wherein the transmission operation is halted and reset to thereby enable the transmission apparatus to recover from the abnormal state in the data transmission in the transmission apparatus by which the transmission abnormality is detected in transmit data;
a step wherein a recovery notice is created and transmitted to the reception apparatus via the packet communication different to the data transmission and the transmission operation is restarted after the transmission of the recovery notice is completed in the transmission apparatus; and
a step wherein the data reception operation is reset at a timing by which the recovery notice is received to thereby synchronize the timing by which the data reception operation is restarted with a timing by which the data transmission operation is restarted in the reception apparatus by which the recovery notice is received.

13. A transmission apparatus for implementing the wireless transmission method as claimed in claim 12, comprising:
a buffer volume supervision device for supervising the transmission abnormality in the transmit data and enabling the transmission apparatus to recover from the abnormal state in the data transmission by halting and resetting the transmission operation when the transmission abnormality is detected in the transmit data;
a recovery request reception device for enabling the transmission apparatus to recover from the abnormal state in the data transmission by halting and resetting the transmission operation in response to the reception of the recovery request transmitted by the reception apparatus via the packet communication different to the data transmission; and
a recovery completion/recovery notice transmission device for transmitting the recovery notice to the reception apparatus via the packet communication different to the data transmission when a recovery operation for the transmission apparatus performed by the buffer volume supervision device is completed, transmitting the recovery completion notice to the reception apparatus via the packet communication different to the data transmission when the recovery operation for the transmission apparatus performed by the recovery request reception device is completed, and restarting the data transmission operation at a timing by which the recovery notice or the recovery completion notice is transmitted.

14. A reception apparatus for implementing the wireless transmission method as claimed in claim 12, comprising:
a buffer volume supervision device for supervising the transmission abnormality in receive data and enabling the reception apparatus to recover from the abnormal state in the data transmission by halting and resetting the reception operation when the transmission abnormality is detected in the receive data;
a recovery request transmission device for transmitting the recovery request for the transmission apparatus to the transmission apparatus via the packet communication different to the data transmission when a recovery operation for the reception apparatus is completed; and
a recovery completion/recovery notice reception device for restarting the data reception operation when the recovery notice or the recovery completion notice transmitted to the reception apparatus by the transmission apparatus via the packet communication is received at a timing of the reception.

15. A wireless transmission method for transmitting data having continuity in real time maintaining the continuity from a transmission apparatus to a reception apparatus, characterized in that
the transmission and reception apparatuses respectively notify the other apparatus of a buffer volume of transmit data and a buffer volume of receive data via packet communication different to the data transmission prior to the real-time transmission of the data, and
the transmission apparatus and the reception apparatus respectively predict a timing by which a transmission abnormality is generated in the other apparatus from the notified buffer volumes and reset their own transmissions in synchronization with the predicted timing by which the transmission abnormality is generated in the other apparatus.

16. A wireless transmission method for transmitting data having continuity in real time maintaining the continuity from a transmission apparatus to a reception apparatus, comprising:
as a process before the real-time transmission of the data is started,
a step wherein the transmission apparatus and the reception apparatus respectively notify the other apparatus of a transmission-side buffer volume and a reception-side buffer volume via packet communication different to the data transmission; and
a step wherein a transmit buffer volume comparison/supervision value is modified to be thereby equal to the received reception-side buffer volume when the received reception-side buffer volume is smaller than the transmission-side buffer volume in the transmission apparatus; and
a step wherein the reception-side buffer volume is modified to be thereby equal to the received transmission-side buffer volume when the received transmission-side buffer volume is smaller than the reception-side buffer volume in the reception apparatus, and further comprising:
as a process after the real-time transmission of the data is started,
a step wherein a transmission operation is halted and reset based on the judgment that an abnormality is generated in the data transmission when a detected value of a transmit-data buffer volume is larger than the transmit buffer volume comparison/supervision value which is previously set to thereby enable the transmission apparatus to recover from an abnormal state in the data transmission and the transmission operation is thereafter restarted in the transmission apparatus; and
a step wherein a reception operation is halted and reset when the abnormality in accordance with the reception-side buffer volume is generated in the data transmission to thereby enable the reception apparatus to recover from the abnormal state in the data transmission and the reception operation is thereafter restarted in the reception apparatus.

17. A transmission apparatus for implementing the wireless transmission method as claimed in claim 16, comprising:
a buffer volume transmission device for transmitting the transmission-side buffer volume to the reception apparatus via the packet communication different to the data transmission;
a buffer volume reception device for receiving the reception-side buffer volume from the reception apparatus and modifying the transmit buffer volume comparison/supervision value to be thereby equal to the reception-side buffer volume when the transmission-side buffer volume is larger than the reception-side buffer volume; and
a buffer volume supervision device for enabling the transmission apparatus to recover from the abnormal state in the data transmission by halting and resetting the transmission operation when the abnormality generated in the data transmission is detected from the detected value of the transmit-data buffer volume larger than the transmit buffer volume comparison/supervision value and thereafter restarting the transmission operation.

18. A reception apparatus for implementing the wireless transmission method as claimed in claim 16, comprising:
a buffer volume transmission device for transmitting the reception-side buffer volume to the transmission apparatus via the packet communication;
a buffer volume reception device for receiving the transmission-side buffer volume from the transmission apparatus and modifying the reception-side buffer volume to be thereby equal to the transmission-side buffer volume when the transmission-side buffer volume is smaller than the reception-side buffer volume; and
a buffer volume supervision device for enabling the reception apparatus to recover from the abnormal state in the data transmission by halting and resetting the reception operation when the abnormality in accordance with the set reception-side buffer volume generated in the data transmission is detected and thereafter restarting the reception operation.

19. A wireless transmission method for transmitting data having continuity in real time maintaining the continuity from a transmission apparatus to a reception apparatus, comprising:
as a process before the real-time transmission of the data is started,
a step wherein a reception-side buffer volume is notified to the transmission apparatus via packet communication different to the data transmission in the reception apparatus;
a step wherein a time difference between time points when an abnormal state is generated in the data transmission in the transmission and the reception apparatuses is calculated from a differential between the received reception-side buffer volume and a transmission-side buffer volume which is previously memorized and a data transfer rate in the transmission apparatus; and
a step wherein a transmit buffer volume comparison/supervision value is modified to be thereby equal to the received reception-side buffer volume and a timing of a recovery from the abnormal state in the data transmission is set allowing no delay when the received reception-side buffer volume is smaller than the transmission-side buffer volume which is previously memorized, while the timing of the recovery from the abnormal state in the data transmission is delayed by the time difference when the received reception-side buffer volume is larger than the transmission-side buffer volume which is previously memorized in the transmission apparatus in the transmission apparatus, and further comprising:
as a process after the real-time transmission of the data is started,
a step wherein a transmission operation is halted and reset in the state where a processing timing is delayed according to the delay setting for the recovery timing which is previously set based on the judgment that an abnormality is generated in the data transmission when a detected value of a transmit-data buffer volume is larger than the transmission buffer volume comparison/supervision value which is previously set to thereby enable the transmission apparatus to recover from the abnormal state in the data transmission and a reception operation is thereafter restarted in the transmission apparatus; and
a step wherein the reception operation is halted and reset when the abnormality in accordance with the reception-side buffer volume is generated in the data transmission to thereby enable the reception apparatus to recover from the abnormal state in the data transmission and the reception operation is thereafter restarted in the reception apparatus.

20. A transmission apparatus for implementing the wireless transmission method as claimed in claim 19, comprising:
a buffer volume reception device for receiving the reception-side buffer volume from the reception device, calculating the time difference between the time points when the abnormal state is generated in the data transmission in the transmission and the reception apparatuses from the differential between the received reception-side buffer volume and the transmission-side buffer volume which is previously memorized and the data transfer rate, and modifying the transmit buffer volume comparison/supervision value to be thereby equal to the received reception-side buffer volume and setting the timing of the recovery from the abnormal state in the data transmission allowing no delay when the received reception-side buffer volume is smaller than the transmission-side buffer volume which is previously memorized, and, on the contrary, setting the timing of the recovery from the abnormal state in the data transmission so as to delay by the time difference when the received reception-side buffer volume is larger than the transmission-side buffer volume which is previously memorized;
a buffer volume supervision device for halting he transmission operation based on the judgment that the abnormality is generated in the data transmission when the detected value of the transmit-data buffer volume is larger than the transmit buffer volume comparison/supervision value which is previously set and thereafter outputting an instruction to reset the transmission operation; and
a timer for resetting the transmission operation in response to the reset instruction and delaying a timing of the reset by a delay time set by the buffer volume supervision device.

21. A reception device for implementing the wireless transmission method as claimed in claim 19, comprising:
a buffer volume transmission device for transmitting the reception-side buffer volume to the transmission apparatus via the packet communication different to the data transmission; and
a buffer volume supervision device for enabling the reception apparatus to recover from the abnormal state in the data transmission by halting and resetting the reception operation when the abnormality generated in the data transmission is detected in receive data and thereafter restarting the reception operation.
